(19) United States
(12) Patent Application Publication
(10) Pub. No.: US 2018/0281515 A1
(43) Pub. Date: Oct. 4, 2018

(54) WHEEL CENTER CAP REMOVAL TOOL

(71) Applicant: Honda Motor Co., Ltd., Tokyo (JP)

(72) Inventor: Douglas DUFF, Marysville, OH (US)

(21) Appl. No.: 15/474,936

(22) Filed: Mar. 30, 2017

(51) Int. Cl. B60B 31/06; B25B 27/00

(52) U.S. Cl. CPC B60B 31/06; B25B 27/0035

(57) ABSTRACT

A tool for removing a center cap of a wheel includes a cylinder having a first end and a second end, a piston movable axially between a first position and second position within the cylinder, a handle attached to the piston and extending from the second end of the cylinder for pulling the piston from the first position to the second position, and an adhesive ring on the first end of the cylinder for creating a seal between the first end of the cylinder and the center cap. Movement of the piston from the first position to the second position creates suction when the adhesive ring is in contact with the center cap to remove the center cap without damaging it.

### TECHNICAL FIELD

The embodiments disclosed herein relate to tools for use with a vehicle wheel.

### BACKGROUND

A press-fit, such as snap in place, cap is positioned to cover the center of most wheels. If the cap needs to be removed for service, options include wedging a screwdriver between the cap and the wheel and prying it off, drilling a hole through the cap and inserting a wire or other apparatus to hook on the opposite side of the cap and allowing the cap to be pulled out, or removing the wheel from the vehicle and pressing the cap outward from the opposite side of the cap.

The current solutions for removing the center cap are deficient in some manner. For example, using a screwdriver to pry the cap off may damage the cap or worse, the wheel. This is especially detrimental to a vehicle that include expensive wheels. Further, drilling a hole through the center cap destroys the center cap. Finally, removing the wheel from the vehicle adds the additional process steps needed to remove the wheel and also to put the wheel back on the vehicle, including re-torqueing the lug nuts to ensure it is properly attached.

### APPLICATION SUMMARY

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

According to one aspect, a tool for removing a center cap of a wheel includes a cylinder having a first end and a second end, a piston movable axially between a first position and second position within the cylinder, a handle attached to the piston and extending from the second end of the cylinder for pulling the piston from the first position to the second position, and an adhesive ring on the first end of the cylinder for creating a seal between the first end of the cylinder and the center cap. Movement of the piston from the first position to the second position creates suction when the adhesive ring is in contact with the center cap.

According to another aspect, a method for removing a center cap of a wheel of a vehicle includes the steps of providing a tool comprising a cylinder having a first end and a second end, a piston movable axially between a first position and second position within the cylinder, and a handle attached to the piston and extending from the second end of the cylinder for pulling the piston from the first position to the second position, placing an adhesive ring on the first end of the cylinder for creating a seal between the first end of the cylinder and the center cap, placing the adhesive ring of the tool on the center cap of the wheel to create a seal, pulling the piston from the first position to the second position to create suction, and removing the tool from the wheel to pull the cap off the wheel.

According to yet another aspect, a system for removing a center cap of a wheel includes a tool including a cylinder having a first end and a second end, a piston movable axially between a first position and second position within the cylinder, and a handle attached to the piston and extending from the second end of the cylinder for pulling the piston from the first position to the second position. Movement of piston from the first position to the second position creates suction to remove the center cap.

### BRIEF DESCRIPTION OF THE DRAWINGS

FIG. 1 is side view of a wheel with a center cap.

FIG. 2 is a rear view of the center cap of the wheel.

FIG. 3 is a side view of a tool for removing the center cap of the wheel.

FIG. 4 is a front perspective view of the tool for removing the center cap of the wheel.

FIG. 5 is a cross-sectional view of the tool taken along line A-A of FIG. 4.

FIG. 6 is one embodiment of a top view of a cylinder and handle of the tool.

FIG. 7 is a side view of a wheel showing operation of the tool.

FIG. 8 is a side view of a portion of the tool illustrating removal of a center cap from the tool.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

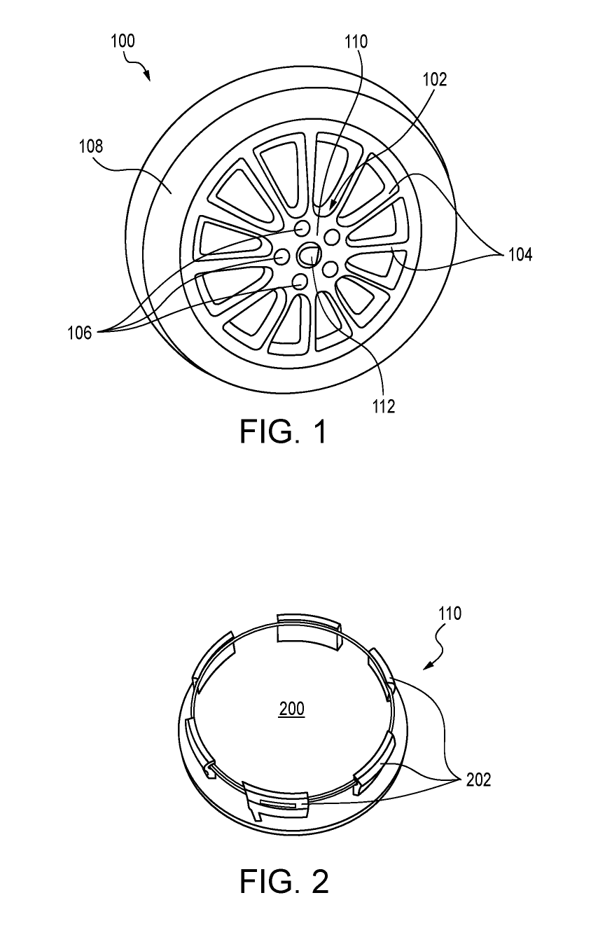

FIG. 1 is an illustration of a wheel 100 for a vehicle. The wheel 100 includes a central rim portion 102, a number of decorative spokes 104, lug nuts 106 for holding the wheel 100 to a hub (not shown), a tire 108 installed circumferentially around the central rim portion 102, and a center cap 110. The center cap 110 may include indicia 112 showing a maker's trademark or logo, or may otherwise be decorative. Furthermore, some known center caps 110 may include openings defined therein that facilitate coupling the indicia 112 to the center cap 110 (e.g., pins on rear of the indicia 112 are pressed into the center cap openings).

FIG. 2 is an illustration of the rear side 200 of the center cap 110. As shown, the center cap 110 may include a plurality of interference fit fasteners 202 that secure the center cap 110 to the wheel 100. Due to the decorative nature of the center cap 110, there is a need for a method to remove the center cap 110 in the event the wheel 100 requires service without damaging the center cap 110 or the wheel 100. Use of tools such as a screwdriver to pop off the center cap 110 may damage the center cap 110 or the wheel 100. Removing the wheel 100 by removing the lug nuts 106 for the purpose of reaching the center cap 110 from the rear of the wheel 100 may be time and cost prohibitive.

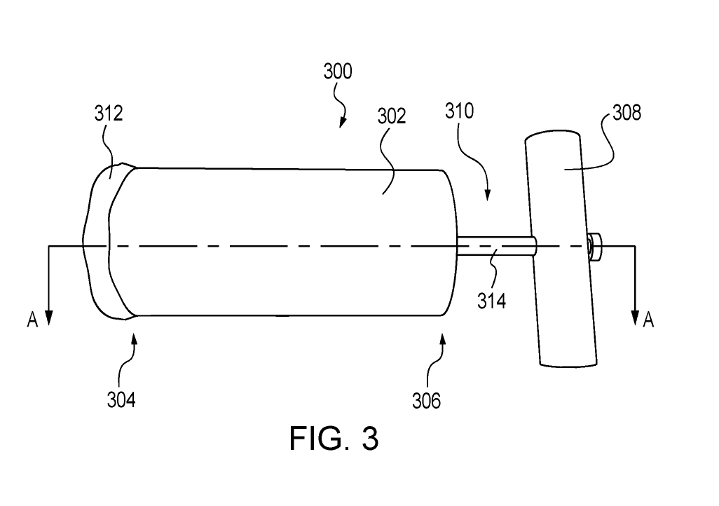

FIGS. 3-5 are illustrations of a tool 300 for removing the center cap 110 of the wheel 100 without damaging the center cap 110 or the wheel 100. The tool 300 includes a cylinder 302 having a first end 304 and second end 306, a piston 400 movable within the cylinder 302, a handle 308, and a connector 310 for connecting the handle 308 to the piston 400. The cylinder 302, piston 400, and handle 308 may be made of any suitable material, such as a thermoplastic or polymers thereof. The tool 300 may also include an adhesive ring 312 around the first end 304 of the cylinder 302.

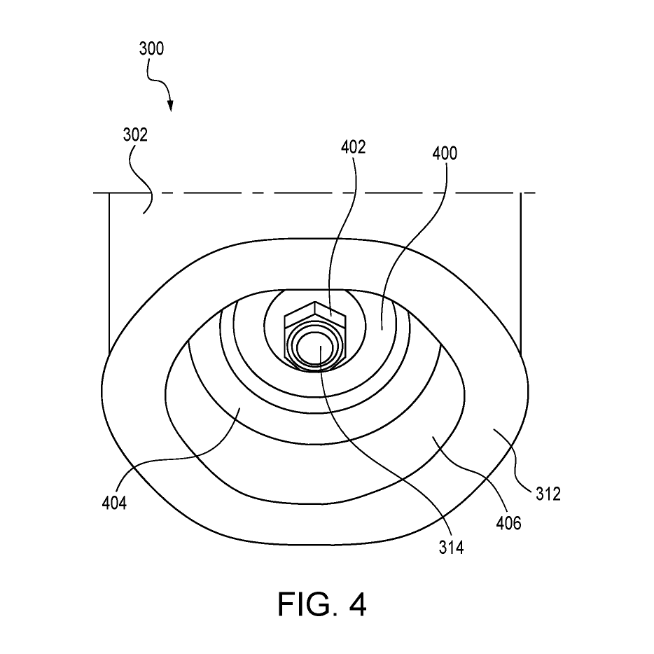

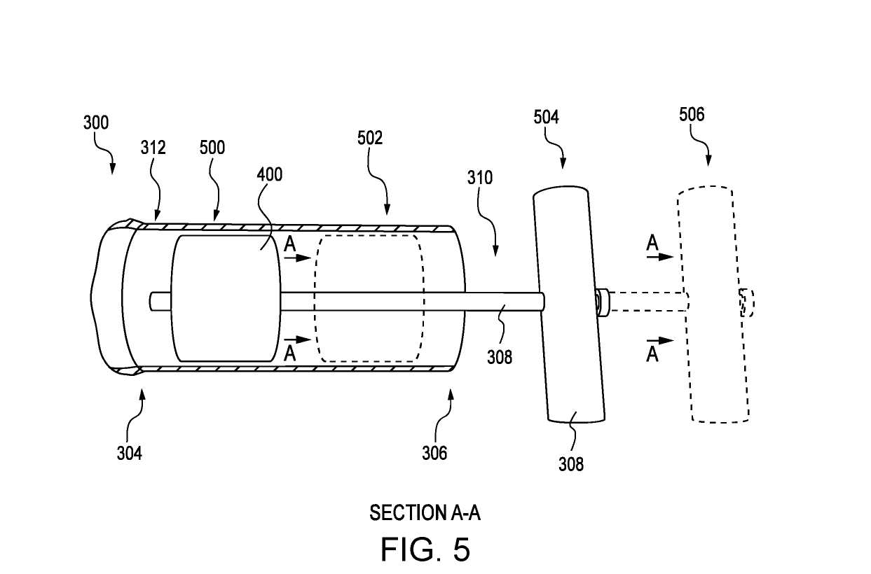

As illustrated in FIG. 5, which is a cross-section of the tool 300 taken along line A-A shown in FIG. 4, the piston 400 is movable from a first position 500, shown in solid lines, in the directions of arrows A, to a second position 502, shown in broken lines. The piston 400 is movable by grabbing the grip of the handle 308 and pulling the handle 308 from a first position 504, shown in solid lines, in the directions of arrows A, to a second position 506, shown in broken lines, which causes the connector 310 to move the piston 400.

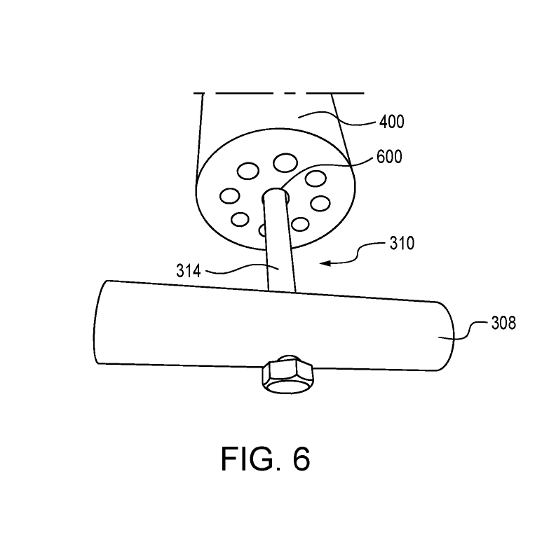

The rod 310 may be a long bolt 314, or any other suitable connector, which extends through the handle 308 and through a hole 600 in the cylinder 302, as illustrated in FIG. 6, and is secured to the piston 400 by a nut 402, or any other suitable fastener as shown in FIG. 4.

As illustrated in FIG. 4, the piston 400 may include a piston ring 404 for providing an improved seal between the piston 400 and the inner wall 406 of the cylinder 302. In an alternate embodiment, the piston ring 404 may be located around an outer wall 700 of the piston 400 for engagement with the inner wall 406 of the cylinder 302.

This engagement allows the piston 400 to move with respect to the cylinder 302 while maintaining a substantially air tight seal between the piston 400 and the cylinder 302. In operation, when the center cap 110 covers the first end 304 and the piston 400 is moved from the first position 500 to the second position 502, air pressure is reduced within the cylinder 302, which exerts a force on the center cap 110 drawing it toward the tool 300 (i.e., the center cap 110 is drawn toward the tool 300 by suction).

With continuing reference to FIGS. 3 and 4, the adhesive ring 312 may be a permanently attached tacky substance, or may be a replaceable tacky substance that is removed and reapplied with each use or after a number of uses. In the embodiments illustrated herein, the adhesive ring 312 is a replaceable tacky substance made of butyl rubber adhesive. It should be understood that the adhesive ring 312 should be tacky with enough holding force to aid in removal of the center cap 110 without creating a substantial or permanent adherence between the tool 300 and the center cap 110 that would damage the center cap 110.

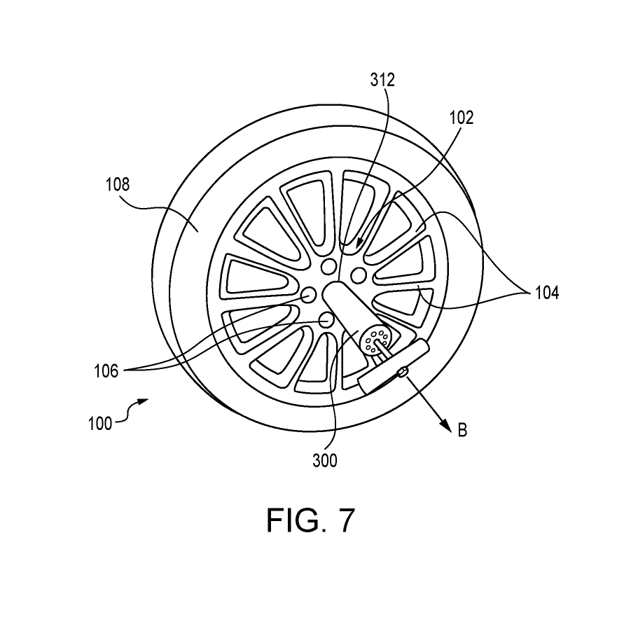

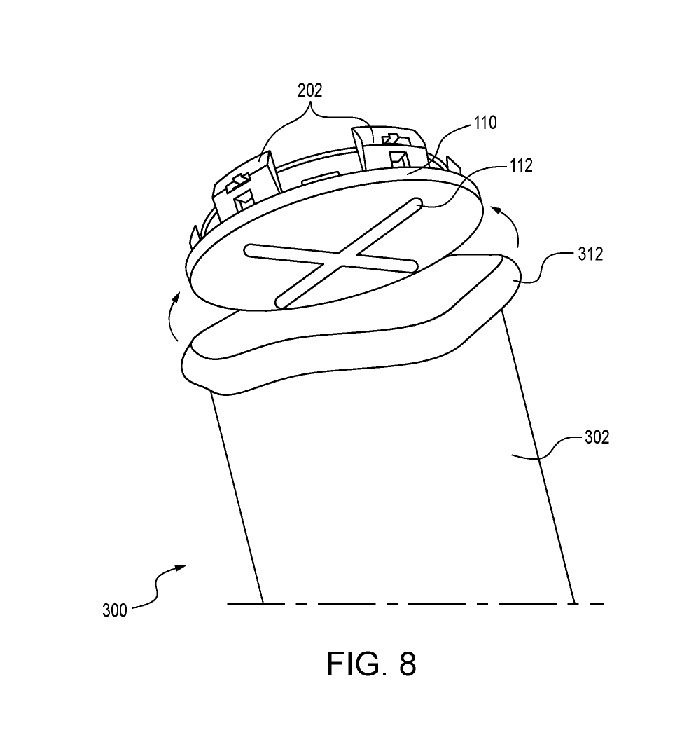

FIGS. 7 and 8 illustrated operation the tool 300 to remove the center cap 110 of the wheel 100. The tool 300 is provided with the adhesive ring 312 on the first end 304 of the cylinder 302. As illustrated in FIG. 5, the piston 400 is set in the first position 500. As illustrated in FIG. 7, the tool 300 is placed so that the adhesive ring 312 engages with the center cap 110. The adhesive ring 312 is configured to provide a substantially air tight seal between the tool 300 and the center cap 110 as well as removably adhesively couple the tool 300 to the center cap 110. With the adhesive ring 312 engaged, the handle 308 is pulled in the direction of Arrow B, moving it from its first position 504 to its second position 506, which in turn moves the piston 400 from the first position 500 to the second position 502. In the second position 502, the piston 400 contacts the second end 306 of the cylinder 302, transferring the pulling force on the handle 308 to the cylinder 302 in the direction of Arrow B. With adhesive ring 312 engaged, an increased volume in the first end 304 of the cylinder 302 creates lower pressure within the first end 304 of the cylinder 302, thereby creating suction on the center cap 110. A combination of the holding force of the adhesive ring 312, and the suction created by the piston 400 and the cylinder 302, holds the center cap 110 against the cylinder 302, which allows the force of the piston 400 against the second end 306 of the cylinder 302 to be transferred to the center cap 110, disengaging and removing the center cap 110 from the wheel 100. In some embodiments, a user holds the cylinder 302 in one hand, pressing the cylinder 302 against the center cap 110. The user pulls on handle 308 in the direction of Arrow B and the abrupt force of the piston 400 against the cylinder 302 is transferred to the center cap 110 and disengages the center cap 110 from the wheel 100. As illustrated in FIG. 8, the center cap 110 may then be removed from the adhesive ring 312. Since the adhesive ring 312 does not damage the center cap 110, the center cap 110 may be wiped off and reused.

In an alternate embodiment, additional sources of suction, such as vacuum appliances, may be used in conjunction with the tool 300 to remove a center cap 110.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A tool for removing a center cap of a wheel, comprising:
a cylinder having a first end and a second end;
a piston movable axially between a first position and second position within the cylinder;
a handle attached to the piston and extending from the second end of the cylinder for pulling the piston from the first position to the second position; and
an adhesive ring on the first end of the cylinder for creating a seal between the first end of the cylinder and the center cap;
wherein movement of the piston from the first position to the second position creates suction when the adhesive ring is in contact with the center cap.

2. The tool of claim 1 wherein the piston further comprises:
a piston ring around a circumference of the piston for providing a seal between the piston and the cylinder.

3. The tool of claim 1 wherein the cylinder includes a stop at the second end of the cylinder that prevents the piston from being removed from the second end of the cylinder.

4. The tool of claim 3 wherein contact between the piston and the stop transfers force applied to the handle to the cylinder, which accordingly is transferred to the center cap.

5. The tool of claim 1 wherein the adhesive ring is constructed from butyl rubber.

6. The tool of claim 5 wherein the adhesive ring is removable.

7. The tool of claim 1 wherein the handle comprises:
a rod extending along a central axis of the cylinder, the rod having a first end attached to the piston and second end; and
a grip extending perpendicularly at the second end of the rod.

8. The tool of claim 7 wherein the rod extends through the piston.

9. The tool of claim 8 wherein the rod is attached to the piston by a fastener.

10. The tool of claim 9 wherein the first end of the rod is threaded and received by a nut.

11. A method for removing a center cap of a wheel of a vehicle, comprising the steps of:
providing a tool comprising a cylinder having a first end and a second end, a piston movable axially between a first position and second position within the cylinder, and a handle attached to the piston and extending from the second end of the cylinder for pulling the piston from the first position to the second position;
placing an adhesive ring on the first end of the cylinder for creating a seal between the first end of the cylinder and the center cap;
placing the adhesive ring of the tool on the center cap of the wheel to create a seal;
pulling the piston from the first position to the second position to create suction between the tool and the center cap; and
removing the tool from the wheel to pull the center cap off the wheel.

12. A system for removing a center cap of a wheel, comprising:
a tool, comprising:
a cylinder having a first end and a second end;
a piston movable axially between a first position and second position within the cylinder; and
a handle attached to the piston and extending from the second end of the cylinder for pulling the piston from the first position to the second position; and
wherein movement of piston from the first position to the second position creates suction to remove the center cap.

13. The system of claim 12 further comprising:
an adhesive ring on the first end of the cylinder for creating a seal between the first end of the cylinder and the center cap.

14. The system of claim 13 wherein the adhesive ring is constructed from butyl rubber.

15. The system of claim 14 wherein the adhesive ring is removable.

16. The system of claim 12 wherein the piston further comprises:
a piston ring around a circumference of the piston for providing a seal between the piston and the cylinder.

17. The system of claim 15 wherein the handle comprises:
a rod extending along a central axis of the cylinder, the rod having a first end attached to the piston and second end; and
a grip extending perpendicularly at the second end of the rod.

18. The system of claim 17 wherein the rod extends through piston.

19. The system of claim 18 wherein the rod is attached to the piston by a fastener.

20. The system of claim 19 wherein the first end of the rod is threaded and received by a nut.
